(19) United States
(12) Patent Application Publication
(10) Pub. No.: US 2026/0360123 A1
(43) Pub. Date: Nov. 12, 2026

(54) METHOD FOR DIGITAL IMAGE PROCESSING

(71) Applicant: K | LENS GMBH, Saarbrücken (DE)

(72) Inventors: Klaus ILLGNER-FEHNS, Starnberg (DE); Sunil Prasad JAISWAL, Saarbrücken (DE); Faranak SHAMSAFAR, Berlin (DE)

(21) Appl. No.: 19/102,059

(22) PCT Filed: Jun. 28, 2023
(86) PCT No.: PCT/EP2023/067663

§ 371 Date: Feb. 7, 2025

(30) Foreign Application Priority Data
Aug. 10, 2022 (LU) LU502654

(51) Int. Cl. G06V 10/774; G06T 7/00; G06T 11/00; G06V 10/147; G06V 10/26; G06V 10/72; G06V 10/764; G06V 10/82; G06V 20/70

(52) U.S. Cl. CPC G06V 10/774; G06T 7/0004; G06T 11/00; G06V 10/147; G06V 10/72; G06V 10/764; G06V 10/82; G06V 20/70; G06T 2207/20081; G06T 2207/20084; G06T 2207/30141; G06T 2207/30164; G06V 10/26; G06V 2201/06

(57) ABSTRACT

A digital image processing method, a computer program product and a device for carrying out the method, wherein a training dataset for a machine learning system for digital image processing, in particular image classification and/or object detection and/or segmentation, is formed. At least one set of digital images of a same captured object from different angles is used for forming the dataset.

The invention relates to a digital image processing method, wherein a dataset, in particular a training dataset, for a machine learning system for digital image processing, in particular, image classification and/or object detection and/or segmentation, is formed.

Such methods are widely being used for a large range of image processing and computer vision tasks. Machine learning systems such as neural networks are often trained using a variety of single images of different scenes. However, obtaining a large number of images of scenes for which the machine learning system should be trained is complex. For augmenting the datasets with variations of each scene, data augmentation is conducted by processing the images for creating additional and differing images from the respective scene and the network is trained using the augmented dataset.

It is an object of the invention to simplify the preparation of a suitable training dataset.

A digital image processing method achieving this object is characterised in that at least one set of digital images of a same captured object from different angles is used for forming the dataset.

Advantageously, particularly good training results can be achieved using at least two preferably several, images that show the same object from different perspectives. The invention makes it possible, to increase the overall size of datasets and the overall model (network) performance, to reduce data imbalance, and the effort of labelling. In particular, in cases in which it is difficult to collect a large number of images for the datasets, e.g. for defect detection in components in industrial applications, providing images of the same object from different angles largely simplifies the generation of suitable datasets for training purposes.

The method is particularly suitable for image classification, in particular fine-grained image classification, object detection and/or segmentation.

Expediently, the machine learning system is a deep learning system such as a convolutional neural network system. Convolutional neural network systems are known to be applied for visual image analysis. They are used in image and video recognition, image classification, and medical image analysis, among others. Furthermore, the machine learning system can be a deep neural network system, a deep belief network system or a recurrent neural network system.

In a particularly preferred embodiment of the invention, the machine learning system is provided for classification, segmentation and/or object detection.

Expediently, multiple sets of digital images respectively of a same captured object are used, wherein at least two of the sets, preferably all sets, differ in the captured perspective.

Preferably, the dataset comprises a ground truth image set and/or a labelled image set which is provided for comparing and/or evaluating the performance of image processing, in particular during the training.

Alternatively, or additionally, an unsupervised learning or a semi-supervised learning model can be applied.

In a preferred embodiment of the invention the method comprises training the machine learning system for digital image processing, in particular classification, segmentation and/or object detection, using the training dataset.

In a further embodiment of the invention the images are captured using a camera, preferably a plenoptical imaging system, in particular a kaleidoscope, preferably generating simultaneously multiple images of an object. Preferably, each of the multiple images is captured from a different angle. The digital images of each set preferably are captured in a single shot.

Any other plenoptical device, e.g. a so-called “standard plenoptic camera” comprising a multitude of micro-lenses or a multi-camera array system, can be used for image generation.

Furthermore, the images of the same object from different angles can be produced by arranging a conventional camera in different positions relative to the object and capturing and image from each position.

In a preferred embodiment of the invention, the set of digital images of the same captured object from different angles is used for determining information relating to the distance of the object or sections or points of the object from the camera in respect to each captured pixel. WO 2014/124982 A1 describes this technique among others for a kaleidoscope. The principles have been invented a century ago, but digital camera technology made them practical. Virtual refocussing and view point change within the limits of the main camera lens, but also depth estimation are possible applications (as described in “Globally Consistent Depth Labeling of 4D Lightfields”. In Proc. CVPR, 41-48. WANNER, S., AND GOLDLUECKE, B. 2012, and “Dynamically Reparameterized Light Fields”. In Proc. SIGGRAPH, 297-306 ISAKSEN, A., MCMILLAN, L., AND GORTLER, S. J. 2000).

The determined depth information can be used, for example, to focus the image for different object field depths. Regarding the present invention, the determined depth information preferably is used to link data from different images, in particular form different angles.

Due to the different positions from which the digital images are captured and an according parallax, the object and/or parts thereof appear in shifted positions in the digital images. Expediently the parallax and according appearance shifts are determined, preferably using a suitable algorithm, in particular considering the depth information outlined below.

Expediently the according information is used for labeling, in particular for transferring at least one label issued for one of the images of a set to other images of the same set.

In addition or alternatively, the according information may be used for linking the images of one set for receiving a better image processing result.

In the preferred embodiment of the invention, the plenoptical imaging system, in particular for a camera, has a plurality of imaging means which are arranged in succession in the direction of an optical axis and comprise a first imaging means for generating a real intermediate image of an object in an intermediate image plane, a second imaging means for generating at least one virtual mirror image of the real intermediate image, which is arranged in the intermediate image plane offset from the real intermediate image, and a third imaging means for jointly imaging the real intermediate image and the virtual mirror image as a real image on an image receiving surface to be arranged at an axial distance from the intermediate image plane.

The kaleidoscope preferably is comprised of at least one pair of flat mirror surfaces, the mirror surfaces facing and spaced apart from each other. At least a part, preferably all, of the light paths pass through the space between the mirror surfaces. Preferably, the mirror surfaces are arranged parallel to each other. The kaleidoscope may have two or more pairs of mirrors. The pairs of mirrors can form a tube which is polygonal in cross-section, preferably rectangular. Alternatively, the kaleidoscope could be formed by a cylindrical glass rod with a polygonal cross-section, which has side surfaces and mirrored front surfaces for the entry and exit of light rays. The cross section of the glass rod is preferably in the shape of an isosceles triangle, a rectangle, especially a square, a regular pentagon, hexagon, heptagon or octagon.

Expediently, the imaging system comprises the image-receiving surface and means for processing a real image taken by means of the image-receiving surface. Preferably, the image-receiving surface has at least one image-receiving sensor or is formed by at least one image-receiving sensor. In the preferred embodiment of the invention, the image-receiving surface is formed by a single image-receiving sensor. The image-receiving sensor is preferably a CCD sensor or a CMOS sensor.

In a further embodiment of the invention, the above-mentioned imaging system has a device for optical filtering which is provided for filtering at least single of the shots captured with the imaging system.

Expediently, the image of the real intermediate image and/or at least one of the virtual mirror images can be filtered separately from one another, in particular as described in WO2022063746A1.

Expediently, the device for optical filtering has at least two optical filters and preferably at least two of the optical filters differ in their filter properties. At least two of the optical filters preferably differ in their filter properties. The filter device can include at least one of the following filters: polarization filter, UV blocking filter, color filter, infrared blocking filter, neutral density filter, edge filter, interference filter, complementary color filter and/or fluorescence filter. The optical filters can differ in their respective filter properties, even if several filters of the same type are used. For example, polarization filters can differ in their orientation, interference filters in the respective wavelength-dependent transmittance, edge filters in the respective separation of the spectral ranges, neutral density filters in their neutral densities and/or complementary color filters in the respective color-specific wavelength-dependent permeability.

In particular when using different neutral density filters, which preferably have different neutral densities from one another, it is possible to create an HDR image (high dynamic range) with a single shot. In particular, videos can also be created in HDR.

Furthermore, it is possible, by processing the differently filtered images, to simulate at least one filter effect, in particular to calculate it, for example by interpolating images that have been recorded with different filters. For example, an orange filtered image can be created from a red and green filtered image.

Preferably, the method is used for processing single images, e.g. photographed or/and computer-generated, and/or image sequences, e.g. filmed, in particular by video recording, or/and computer-generated.

The computer-generated image or images may be generated in a completely artificial manner.

In a preferred embodiment of the invention, the computer-generated image is rendered from or/and based on the images of the same object from the different angles, the computer-generated image preferably showing the object from an angle differing from the angles of digital images used as a basis for an according rendering process.

In a further embodiment of the invention, the computer-generated images are generated using a computer program suitable for rendering an image from a set of images showing a same captured object from different angles.

In a preferred embodiment of the invention, the computer-generated images are generated considering the determined depth information mentioned above. Expediently, the depth information is used for generating additional perspectives. Preferably, perspectives in between the captured perspectives or perspectives from a larger angle than from the outermost captured position are generated. The computer-generated images can comprise at least one digital image which is generated using at least one of following image processing methods: image rotation, filtering, denoising, blurring, altering of intensity, brightness, sharpness, contrast and/or coloring of at least parts of the digital image, altering positions of at least individual pixels, altering intensities of the representation of at least individual ones of the pixels, vignetting or de-vignetting, and/or digital image filtering, e.g. for altering color, brightness and/or coloring. Expediently, noise may be

In a further embodiment of the invention, the image processing comprises injection of noise. This injection of noise preferably simulates noise injection which . . . typically occurs during electronic processing of the digital images in the course of their capture or/and their further processing.

Expediently, the computer-generated images are used for augmenting the dataset, wherein the computer-generated images preferably are added to the respective set of images based on which they are generated.

Preferably, the augmented dataset is used for training.

In a further embodiment of the invention, the digital images are pre-processed before their use for training. At least one of following image processing methods (mentioned above also for image generation) can be used for pre-processing: image rotation, filtering, denoising, blurring, altering of intensity, brightness, sharpness, contrast and/or coloring of at least parts of the digital image, altering positions of at least individual pixels, altering intensities of the representation of at least individual ones of the pixels, vignetting or de-vignetting, and/or digital image filtering, e.g. for altering color, brightness and/or coloring. The image pre-processing may comprise injection of noise, wherein the injection of noise preferably simulates noise injection which typically occurs during electronic processing of the digital images in the course of their capture or/and their further processing.

The pre-processing may comprise an amendment of at least one of the images of the mentioned set of digital images of a same captured object from different angles, wherein the different angles from which the images of the object are captured or/and generated are considered. In particular, the amendment May consider a parallax resulting from the different angles. For aligning the images, pixels in at least one of the digital images could be relocated, in particular such that pixels showing identical parts of the object are located in identical positions in the digital image. Preferably, an according amendment of the images is provided such that the mentioned depth information is considered, in particular for each pixel.

Expediently, the pre-processing comprises merging of the data from the images of the set of digital images of a same captured object considering the different angles, the depth information and/or parallaxes. Preferably, the merging comprises a provision of pixelwise information which respectively may differ, wherein the information may comprise different features of the image. In a preferred embodiment, the merging results in a feature vector representing the information in a pixelwise manner.

In a further embodiment of the invention, the pre-processing is conducted in an additional pre-processing machine learning system. The pre-processing machine learning system may be trained separately or together with the machine learning system for image processing.

Expediently, targeted processing for better recognition of features to be examined using the machine learning system is provided. The targeted processing preferably comprises masking or/and deleting of information in the digital images that is not relevant for the present processing or/and emphasizing certain structures such as edges, holes, colouring, shapes, shadings, or the like. In particular, all image areas which are known to be irrelevant may be masked or deleted.

In a further embodiment of the invention, cropping the images may be applied. Expediently, at least one of the images is cropped such that at least two cropped images comprising different parts of the image are produced, wherein preferably at least adjacent cropped images overlap.

In a further embodiment of the invention the images are used separately for training. In addition or alternatively, the images are used jointly for training, in particular as at least an image set.

Expediently, suitable artificial intelligence initializing or training routines are used for initializing or pre-training the machine learning system. The initializing or training routines preferably comprise using a standard neural network (such as e.g. ResNET (for classification), YOLO (for detection) or the like), using results if the processing using the standard neural network as feedback for the training using a training logic loss function preferably considering a ground truth or/and a label.

In a preferred embodiment of the invention, a pre-trained neural network is used for initialization, in particular a standard network that has been trained on a, preferably large, public datasets and use their weights for initialization.

Preferably, the training is conducted according to usually used training routines known from the state of the art.

Before starting a training, prepared datasets (consisting of images and ground truth) may be divided into training datasets and validation datasets, wherein the training datasets comprise roughly 80% of the content of the datasets and the validation datasets roughly 20% of the content of the datasets.

Expediently, a model is trained on training datasets and learns the relation between input images and ground truth. During training, the model is validated (or tested) on the validation datasets to confirm that it has learned well on a different dataset than the training datasets. The training preferably is conducted until the model has learned well on both training datasets (model knows the ground truth) and validation datasets (model not knowing the ground truth).

In a preferred embodiment of the invention, in the course of the training of the machine learning system, the result of the image processing using the machine learning system is compared with the result according to the ground truth and/or the label and the machine learning system is trained using artificial intelligence training routines.

The machine learning system preferably is trained by processing the digital images forming probability-weighted associations, which are stored within the data structure of the system. The training preferably is conducted by comparing the generated results and the results according to the ground truth and/or the label, in particular by determining differences between the generated results and the results according to the ground truth and/or the label. In the course of the training, the system preferably adjusts its weighted associations according to a learning rule and using this error value. Advantageously, successive adjustments will cause the machine learning system to produce a more reliable output.

In a preferred embodiment of the invention, results of the digital image processing of the digital images are processed in a machine learning system for result processing.

For training the machine learning system for result processing, the results from the machine learning system for image processing are used separately for training. In addition or alternatively, the results are used jointly for training, in particular as a result set, preferably each comprising results for a set of images of a same captured object from different angles.

Advantageously, using the results of image processing of the set of images of the same captured object from different angles enables an inference of a general result regarding the object, in particular with respect to classification, segmentation and/or object detection.

The machine learning system trained with the images in the inventive manner has an augmented ability to determine details and/or a relationship of the images of the respective object from different angles.

In a further embodiment of the invention, a loss function is used which penalizes mispredictions from different views of the same set of images.

For a binary image classification (e.g. defect versus non-defect), a suitable loss function may be defined as follows, wherein N is the number of training samples in the dataset, v is the index of a perspective or a viewpoint image (M is the number from the available viewpoints), yᵢ is the ground-truth label (either 0 or 1), Iᵥ is the associated viewpoint image and p(yᵢ|Iᵥ) is the probability of having y prediction using the network given the viewpoint image of/v.

$$Loss = - \frac{1}{N} {\sum }_{i = 1}^{N} {\sum }_{v = 1}^{M} {y}_{i} \cdot log ( p ( {y}_{i} \vert {I}_{v} ) ) + ( 1 - {y}_{i} ) \cdot log ( 1 - p ( {y}_{i} \vert {I}_{v} ) ) \qquad ( Loss Function 1 )$$

Alternatively, the loss function can be provided such that the intermediate representation of different views computed from the machine learning system should be as close as possible so that they result in similar predictions. Expediently, the loss function penalizes mutual, preferably pairwise, discrepancies between results. Such loss function does not necessarily require a ground truth and/or a label and thus brings in an unsupervised learning manner for the model. This loss function can be combined with a supervised loss function (e.g. the loss function mentioned one above) where the ground-truth label (yᵢ) is involved.

Such loss function can be defined as follows, wherein N is the number of training samples in the dataset, wherein u and v are the indexes of perspective or viewpoint images, M is the number of available viewpoints, fᵤ and fᵥ are the representations (feature vectors) of the corresponding images, and Sim is a similarity function, e.g. Cosine similarity. Given e.g. M viewpoints, a total of X similarities between representations, i.e. Sim(f₁,f₂), Sim(f₂,f₃), Sim(f₁,f₄), Sim(f₁,f₅), Sim(f₃,f₄), etc. can be computed. As no ground-truth label is used (i.e. it is an unsupervised loss), the loss can be used with a supervised loss (e.g. cross entropy loss) in which a ground-truth label is used.

$$Loss = - \frac{1}{N} {\sum }_{i = 1}^{N} {\sum }_{v = 1}^{M} {\sum }_{\begin{matrix}u = 1 , \\ u \neq v , \\ u > v\end{matrix}}^{M} Sim ( {f}_{v} , {f}_{u} ) \qquad ( Loss Function 2 )$$

In a further embodiment of the invention, the loss function can be provided such that the results of different views computed from the machine learning system should be as close as possible so that they result in similar final results.

Such loss function can be defined as follows, wherein N is the number of training samples in the dataset, u and v are the indexes of a perspective or a viewpoint image (M is the number of available viewpoints), Rᵤ and Rᵥ are the final results regarding the corresponding images, and Sim is a similarity function. Given e.g. M viewpoints, a total of X similarities between representations i.e. Sim(R₁,R₂), Sim(R₂,R₃), Sim(R₁,R₄), Sim(R₁,R₅), Sim(R₃,R₄), etc. can be computed. As no ground-truth label is used (i.e. it is an unsupervised loss), the loss can be used with a supervised loss (e.g. cross entropy loss) in which a ground-truth label is used.

$$Loss = - \frac{1}{N} {\sum }_{i = 1}^{N} {\sum }_{v = 1}^{M} {\sum }_{\begin{matrix}u = 1 , \\ u \neq v , \\ u > v\end{matrix}}^{M} Sim ( {R}_{v} , {R}_{u} ) \qquad ( Loss Function 3 )$$

In a further embodiment of the invention, the loss function can be provided such that the results of different views computed from the machine learning system should be as close as possible so that they result in similar predictions and/or similar intermediate representation.

Such loss function can be defined as follows, wherein N is the number of training samples in the dataset, u and v are the indexes of a perspective or a viewpoint image (M is the number of available viewpoints), fᵤ and fᵥ are the intermediate representations (feature vectors) of the corresponding images, and Sim is a similarity function, e.g. Cosine similarity and p(yᵢ|Iₘ) is the probability of having yᵢ prediction using the network given the viewpoint image of Iₘ.

$$Loss = - \frac{1}{N} {\sum }_{i = 1}^{N} {\sum }_{v = 1}^{M} {\sum }_{{u = 1 ,}_{{u \neq v ,}_{u > v}}}^{M} {y}_{i} \frac{1}{2} {Sim}^{2} ( {f}_{v} , {f}_{u} ) log ( p ( {y}_{i} \vert {I}_{v} ) \cdot p ( {y}_{i} \vert {I}_{u} ) ) + ( 1 - {y}_{i} ) \frac{1}{2} {Sim}^{2} ( {f}_{v} , {f}_{u} ) log ( ( 1 - p ( {y}_{i} \vert {I}_{v} ) ) \cdot ( 1 - p ( {y}_{i} \vert {I}_{u} ) ) ) \qquad ( Loss Function 4 )$$

In a further embodiment of the invention, a machine learning system for digital image processing trained as outlined above, in particular the trained machine learning system for image processing, and preferably the pre-processing machine learning system, is used for image processing.

In a further embodiment of the invention, results from the image processing using the machine learning system regarding a set of digital images of a same captured object from different angles are processed considering a proportion of identical results, e.g. such that the result having the greatest proportion is used for the classification, the segmentation and/or the object detection.

Expediently, confidence values form the machine learning system may be considered for weighting of the results. An according algorithm may be defined as follows:

decission=Σᵢαᵢ·cᵢ with c_i=confidence value for perspective i and αᵢ a weight value. Σᵢαᵢ=1

In a preferred embodiment of the invention, the further machine learning system for result processing is used for processing results from the image processing using the machine learning system regarding a set of digital images of a same captured object from different angles or multiple such sets.

Expediently, suitable artificial intelligence initializing or training routines are used for initializing or pre-training the machine learning system for result processing, the initializing or training routines comprising using a standard neural network (e.g. ResNet, YOLO or the like), using results if the processing using the standard neural network as feedback for the training using a training logic loss function preferably considering a ground truth or/and a label. Preferably, the training is conducted by updating the model weights according to the loss value computed from the loss function. This procedure may accomplish using backpropagation with optimization methods like SGD (Stochastic gradient descent), ADAM (Adaptive Moment Estimation), or the like.

In a particularly preferred embodiment of the invention, the image processing is used for classifying images of workpieces for inspections purposes, wherein the inspection preferably is provided for differentiating of defective from non-defective workpieces. Expediently, the classification comprises a differentiation between the defective from the non-defective workpieces. The mentioned ground truth or/and labelling preferably is provided comprising a differentiation information between the defective from the non-defective workpieces.

Furthermore, the invention relates to a computer program product for digital image processing comprising instructions which, when the program is executed by a computer, cause the computer to process a digital image using a machine learning system having been trained carrying out any of the methods steps mentioned above.

Furthermore, the invention relates to a data carrier signal transmitting the computer program product.

In a further embodiment of the invention, the invention relates to a device for digital image processing, comprising means for carrying out the method outlined above.

Expediently, the device for processing the digital image is constituted by a data processing device, in particular a computer, provided in particular for processing data read from the image capture sensor. In an embodiment of the invention, the data processing device is arranged in a housing of a camera which preferably forms part of the imaging system or is arranged for use with the imaging system.

The invention is explained in more detail below using exemplary embodiments and the accompanying drawings which relate to the exemplary embodiments and wherein:

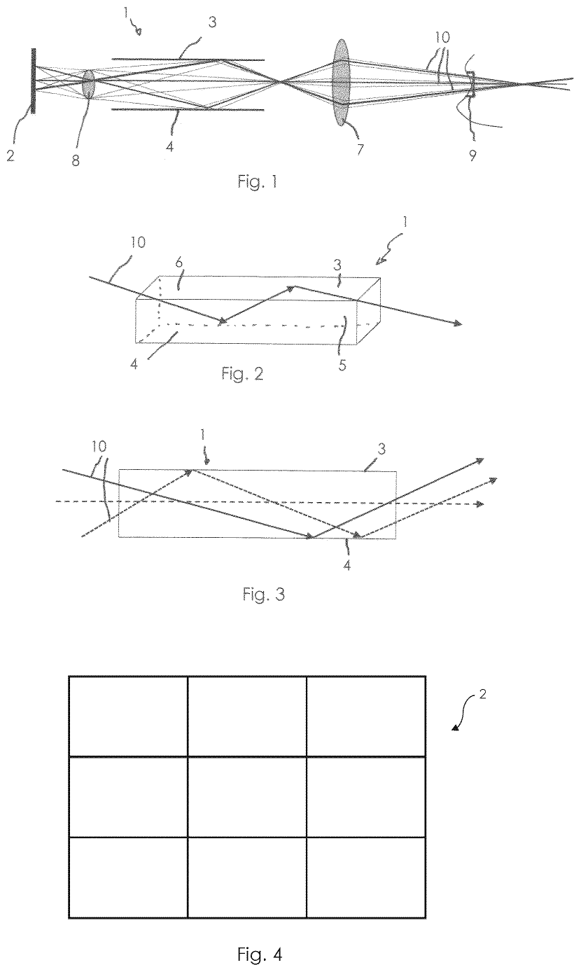

FIG. 1 schematically illustrates details of a plenoptical imaging system,

FIG. 2 schematically illustrates further details of a plenoptical imaging system,

FIG. 3 schematically illustrates further details of a plenoptical imaging system,

FIG. 4 schematically illustrates detail of the method, and

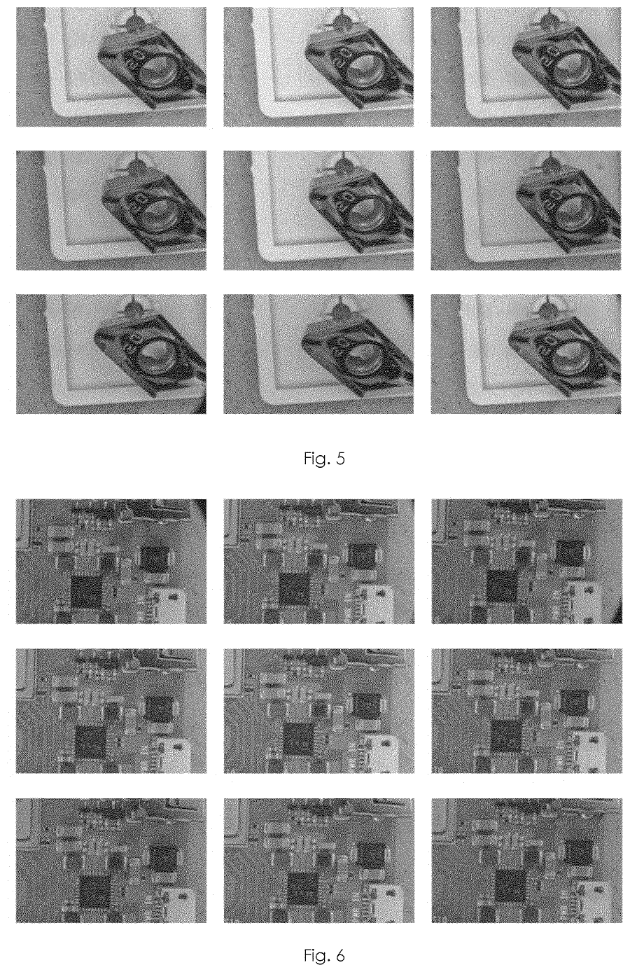

FIG. 5 images captured using a plenoptical imaging system according to FIGS. 1-4,

FIG. 6 images captured using a plenoptical imaging system according to FIGS. 1-4,

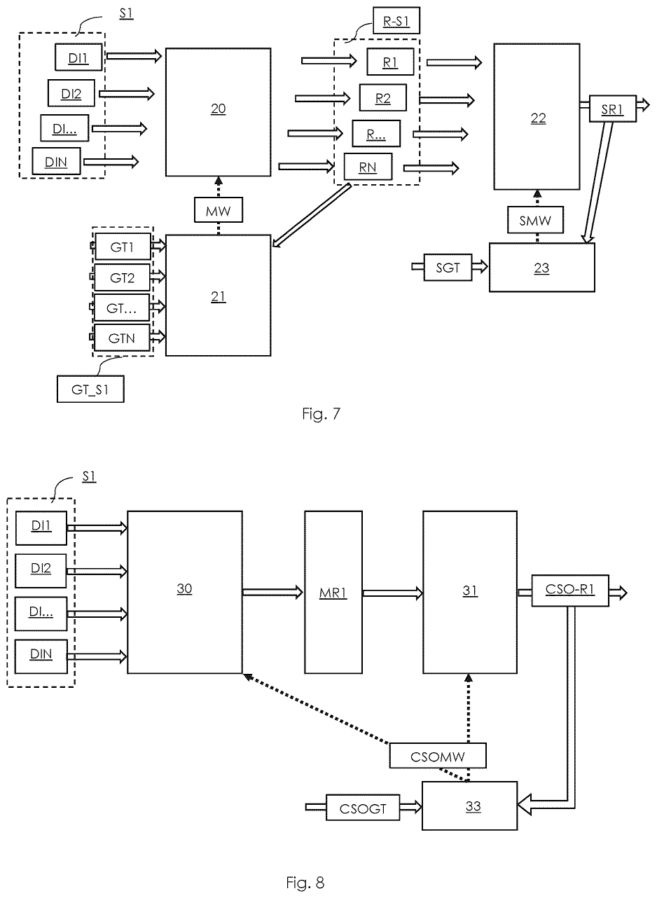

FIG. 7 schematically illustrates an exemplary method according to the invention, and

FIGS. 8-12 schematically illustrate further exemplary methods according to the invention.

For training a machine learning system for digital image processing, in particular for classification, segmentation and/or object detection, images of a same captured object from different angles are used for forming a dataset. The machine learning system is a deep learning system known from the state of the art such as a convolutional neural network system.

In an exemplary embodiment of the invention, the method according to the invention is conducted using original digital images which are captured using a plenoptical imaging system, in particular a plenoptical imaging system comprising a kaleidoscope, generating simultaneously multiple images of an object to be captured. Some details of the plenoptical imaging system are outlined above. Furthermore, FIG. 1 shows schematically how, in accordance with the invention, a plenoptical image capture is produced using a plenoptical imaging device 1 comprising a kaleidoscope which, in addition to an entrance lens 7 and an exit lens 8, has a mirror box comprising mirrors 3,4,5,6 which forms a kaleidoscope. The mirrors 3,4,5,6 are, as shown in FIGS. 2 and 3, arranged in a rectangular cross-section in the mirror box, with the mirror surfaces of the mirrors being arranged on the inside of the mirror box.

Rays of light 10 emanating from an object area 9, which images an object, enter the entrance lens 7 and are directed through the entrance lens into the interior of a mirror box. Some of the light rays 10 pass through the mirror box to the exit lens 8 without striking any of the mirrors 3,4,5,6, while other light rays are reflected only once at one of the mirrors 3,4,5,6 before striking the exit lens 8. Other light rays, in turn, are reflected several times within the mirror box at mirrors 3,4,5,6, whereby reflection can occur both at opposite mirrors 3,4,5,6 and at mirrors 3,4,5,6 arranged adjacent to one another. The exit lens 8 is arranged in such a way that the light rays emerging from the mirror box are guided to your receiver surface 2, which is formed by a sensor, in particular a CCD or CMOS sensor.

The entrance lens 7, the mirrors 3,4,5,6, and the exit lens 8 are arranged in such a way that nine images of the object area are formed on the receiver surface 2, which are generated next to each other in a 3×3 grid such as shown in FIG. 4. An exemplary image captured using the kaleidoscope is shown in FIG. 5. The images are generated in such a way that they form the object area starting from the entrance lens 7 from nine different perspectives or, in other words, angles of view. Alternatively, the entrance lens 7, the mirrors 3,4,5,6 and the exit lens 8 could be arranged in such a way that N×N images of the object area are formed on the receptor surface and generated next to each other in an N×N grid, where N represents an odd number. In addition to the above-mentioned raster, 25 images of the object area in a 5×5 raster or 49 images in a 7×7 raster can be considered. It goes without saying that in order to increase the number of viewing angles that can be achieved, larger numbers of illustrations and corresponding raster arrangements can also be provided.

In the present example, the plenoptical imaging device 1 comprises a plenoptical imaging device comprising a kaleidoscope of the applicant K Lens GmbH. The plenoptical imaging device 1 is arranged in a lens body comprising the components outlined above. It comprises a mounting mechanism (“lens mount”) for mounting the lens body on an actual camera body, e.g. the above mentioned “Nikon D810”, an industrial camera, or the like. It allows imaging of 9 different perspectives of a scene using a single shot on a single camera sensor. The different perspectives can be used for a host of post-processing tasks and applications like post capture focus, determination of depth information, i.e. determination of a distance value to each pixel, etc., Since the sensor now captures 9 different perspectives, the number of pixels for each perspective is about 1/9 of the number of pixels of the full sensor. The goal is to find a way to enhance the resolution of each view.

Alternatively, any other plenoptical device can be used for image generation. Furthermore, it would be possible to capture the images of the same object which are provided for the dataset from different angles arranging a conventional camera in different position relative to the object or by using a camera array composed of individual conventional cameras.

N digital images DI1, . . . , DIN (wherein N≥2) captured using the plenoptical image device 10. The digital images DI1, . . . , DIN can optionally be pre-processed or/and altered before their use for training, e.g. by image rotation, filtering, denoising, blurring, altering of intensity, brightness, sharpness, contrast and/or coloring of at least parts of the digital image, altering positions of at least individual pixels, altering intensities of the representation of at least individual ones of the pixels, vignetting or de-vignetting, and/or digital image filtering, e.g. for altering color, brightness and/or coloring.

Optionally, additional further digital images may be generated using the image processing methods mentioned above for image processing of the digital images DI1, . . . , DIN (wherein N≥2).

A further option for generating further digital images is rendering from or/and based on the digital images DI1, . . . , DIN (wherein N=2) computer-generated images preferably showing the object from an angle differing from the angles of digital images used as a basis for an according rendering process. The computer-generated images are generated using a computer program suitable for rendering an image from a set of images showing a same captured object from different angles. The computer program may consider the depth information used for generating additional perspectives.

FIG. 7 shows schematically process steps of the method according to the invention.

In a first step, N digital images DI1, . . . , DIN (wherein N≥2) of the same object from different angles (as the case may be pre-processed or/and comprising the mentioned computer-generated digital images as mentioned above) are transferred to a neural network 20 of a machine learning system for digital image classification, segmentation and/or object detection, such as a deep learning system, e.g. a convolutional neural network system.

In the present example, a first set S1 of N digital images DI1, . . . , DIN (wherein N≥2) of the same specific object from different angles which have been captured or/and generated as mentioned above are subsequently fed to the image processing neural network 20. For each of the digital images DI1, . . . , DIN, the image processing neural network 20 determines a specific classification, segmentation and/or object detection result R1, . . . , RN. The results R1, . . . , RN form a set of results R-S1.

Each result R1, . . . , RN can be used as feedback for a training logic 21 based on loss function considering a provided set of ground truth GT1, . . . , GTN and generating according model weights MW. For instance, for training logic 21 and for a supervised classification task, the Loss Function 1 shown above can be used.

For preparing the ground truth data or/and the labelled data, different positions from which the digital images are captured and optionally an according parallax, the object and/or parts thereof appearing in shifted positions in the digital images can be considered. The parallax and according appearance shifts are determined using a suitable algorithm, which considers the mentioned depth information mentioned above. This is used for transferring at least one label issued for one of the images of a set to other images of the same set. Using appearance shifts results in simplifying the labeling process, in particular for detection and segmentation. Labels (annotations) for these tasks preferably are rectangular bounding boxes or/and object contours (masks).

The invention considerably reduces high manual effort, which the provision of such annotations usually demands.

In a further, optional, step, the results R1, . . . , RN can be transferred jointly as a result set R-S1 to a result processing neural network 22 considering the totality of the results R1, . . . , RN and putting out a set result SRI regarding the specific object which has been captured in the images of the respective set.

The set result SRI regarding the specific object can be used as feedback for training and is transferred in a training logic 23 based on loss function considering a provided set ground truth SGT and generating according set model weights SMW. For example, for training logic 23 and for a supervised classification task, the Loss Function 1 shown above can be used.

In the same manner further sets S2, . . . , Sn (wherein n≥3; not shown in FIG. 7) of respectively N further digital images of further respective same objects from different angles are processed as mentioned above for the training.

The trained machine learning system comprising the neural networks 20 and 22 is used for classification, segmentation and/or object detection, e.g. for inspection purposes.

For example, digital images of milling inserts such as shown in FIG. 5 may be processed for material defect detection or digital images of circuit boards such as shown in FIG. 6 may be processed for object detection, e.g. for separating different types of circuit boards from each other.

Alternatively or in addition, the results R1, . . . , RN are processed considering a proportion of identical results, e.g. such that the result having the greatest proportion is used for the classification, the segmentation and/or the object detection.

Expediently, confidence values from the machine learning system may be considered for weighting of the results.

In a further example schematically illustrated in FIG. 8, the N digital images DI1, . . . , DIN (wherein N≥2) of the same object from different angles (as the case may be pre-processed or/and comprising the mentioned computer-generated digital images as mentioned above) are transferred to a neural network 30 of a machine learning system for digital image data merging such as a deep learning system, e.g. a convolutional neural network system. The data is merged from the images considering the different angles, the depth information and/or parallaxes so that an information which comprises different features of the images is generated. The neural network 30 for digital image merging outputs a merging result MR1 comprising a feature vector representing the information of the digital image.

The merging result MR1 is transferred to a further neural network 31 of a machine learning system for classification, segmentation and/or object detection such as a deep learning system, e.g. a convolutional neural network system, being provided for processing the merging result MR1 and outputting a classification, segmentation and/or object detection result CSO-R1. The result CSO-R1 can be used as feedback for training and is transferred to a training logic 33 based on loss function considering a provided ground truth CSOGT and generating according model weights CSOMW for the neural networks 30, 31.

If processed in this manner for a multitude of image sets S2, S3, . . . , Sn (wherein n≥2) of respectively N digital images of respective same objects from different angles, each result CSO-R1, . . . , CSO-Rn can be used for training and is transferred in a training logic 33 based on a loss function considering a provided ground truth for classification, segmentation and/or object detection CSOGT and generating according model weights CSOMW. For instance, for training logic 33 and for a supervised classification task, the Loss Function 1 shown above can be used.

The trained machine learning system comprising the neural networks 30, 31 is used for classification, segmentation and/or object detection, in particular for inspection purposes, e.g. for the digital images of milling inserts such as shown in FIG. 5 or the digital images of circuit boards such as shown in FIG. 6.

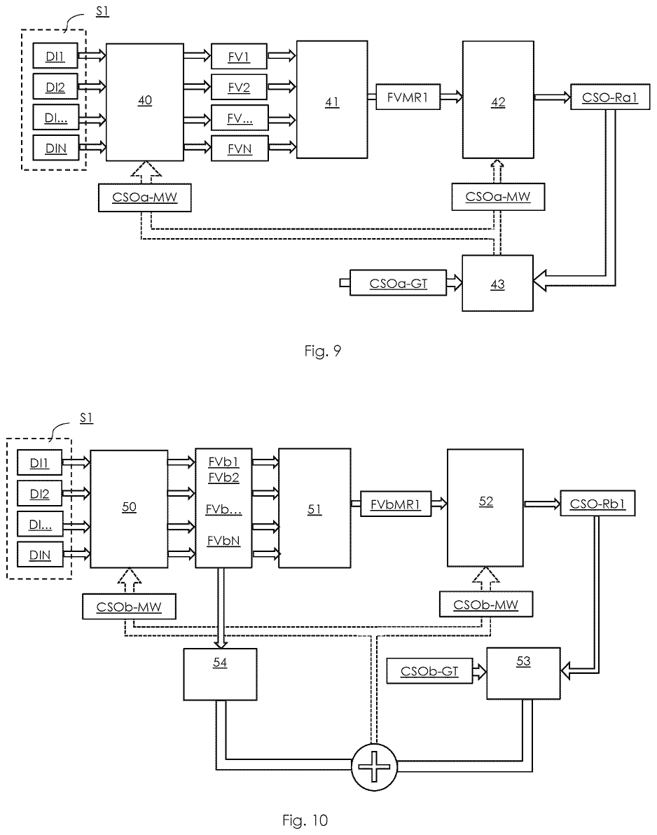

In a further example schematically illustrated in FIG. 9, the N digital images DI1, . . . , DIN (wherein N≥2) of the same object from different angles (as the case may be pre-processed or/and comprising the mentioned computer-generated digital images as mentioned above) are transferred to a neural network 40 of a machine learning system for digital image processing such as a deep learning system, e.g. a convolutional neural network system. The neural network 40 for digital image processing outputs for each digital image DI1, . . . , DIN a feature vector FV1, . . . , FVN representing information of the digital image.

The information from the feature vectors FV1, FV2, . . . , FVN is merged using a merging module 41 which outputs a feature vector merging result FVMR1 comprising a feature vector representing an information of the digital images DI1, . . . , DIN.

The merging result FVMR1 is transferred to a further neural network 42 of a machine learning system for classification, segmentation and/or object detection such as a deep learning system, e.g. a convolutional neural network system, being provided for processing the result FVMR1 and outputting a classification, segmentation and/or object detection result CSO-Ra1. The set result CSO-Ra1 regarding the specific object can be used as feedback for training and is transferred in a training logic 43 based on loss function considering a provided set ground truth CSOa-GT and generating according set model weights CSOa-MW. These model weights CSOa-MW can be fed to the neural networks 40, 42 for training purposes.

If processed in this manner for a multitude of image sets S2, S3, . . . , Sn (wherein n≥2) of respectively N digital images of respective same objects from different angles, each result CSO-Ra1, CSO-Ra2, CSO-Ra3, . . . , CSO-Ran can be used as feedback for a training logic 43 based on a loss function considering a provided ground truth for classification, segmentation and/or object detection CSOa-GT and generating according model weights CSOa-MW. For instance, the Loss Function 1 shown above can be used for training logic 43 and for a supervised classification task.

The trained machine learning system comprising the neural networks 40 and 42 is used for classification, segmentation and/or object detection, in particular for inspection purposes, e.g. for the digital images of milling inserts such as shown in FIG. 5 or the digital images of circuit boards such as shown in FIG. 6.

In a further example schematically illustrated in FIG. 10, the N digital images DI1, . . . , DIN (wherein N≥2) of the same object from different angles (as the case may be pre-processed or/and comprising the mentioned computer-generated digital images as mentioned above) are transferred to a neural network 50 of a machine learning system for digital image pre-processing such as a deep learning system, e.g. a convolutional neural network system. The neural network 50 for digital image processing outputs for each digital image DI1, . . . , DIN a feature vector FVb1, FVb2, . . . , FVbN representing the information of the digital image.

The information from the feature vectors FVb1, FVb2, . . . , FVbN is merged using a merging module 51 which outputs a feature vector merging result FVbMR1 comprising a feature vector representing an information of the digital images DI1, DI2, . . . , DIN.

The feature vectors FVb1, FVb2, . . . , FVbN are transferred to a training logic 54 that does not require ground truth. Ground truth is not required for the training logic 54, because the feature vectors FVb1, FVb2, . . . , FVbN should comprise similar values due to the similarity of the digital images DI1, DI2, DI3, . . . , DIN among each other.

The merging result FVbMR1 is transferred to a further neural network 52 of a machine learning system for classification, segmentation and/or object detection such as a deep learning system, e.g. a convolutional neural network system, being provided for processing the result FVbMR1 and outputting a classification, segmentation and/or object detection result CSO-Rb1. The set result CSO-Rb1 regarding the specific object can be used as feedback for training and is transferred in a training logic 53 based on loss function considering a provided set ground truth CSOb-GT and generating according set model weights CSOb-MW.

Compared to the example according to FIG. 9, the present method comprises additional information, i.e. additional loss values, from the training logic 54. For training logic 54, the Loss Function 2 can be used.

The loss values from the training logics 53,54 are merged, i.e. summed up, wherein the results from the training logics 53,54 may be weighted.

Resulting model weights CSOb-MW are fed to the neural networks 50, 52 for training purposes. If processed in this manner for a multitude of image sets S2, . . . , Sn (wherein n≥3) of respectively N digital images of respective same objects from different angles, each result CSO-Rb1, CSO-Rb2, CSO-Rb3, . . . , CSO-Rbn can be used as feedback for a training logic 53 based on a loss function considering a provided ground truth for classification, segmentation and/or object detection CSOb-GT and generating according model weights CSOb-MW. For instance, for training logic 53 and for a supervised classification task, the Loss Function 1 shown above can be used. The Loss Function 4 shown above can be considered as the final loss function, which merges the result of training logics 53, 54.

The trained machine learning system comprising the neural networks 50 and 52 is used for classification, segmentation and/or object detection, in particular for inspection purposes, e.g. for the digital images of milling inserts such as shown in FIG. 5 or the digital images of circuit boards such as shown in FIG. 6.

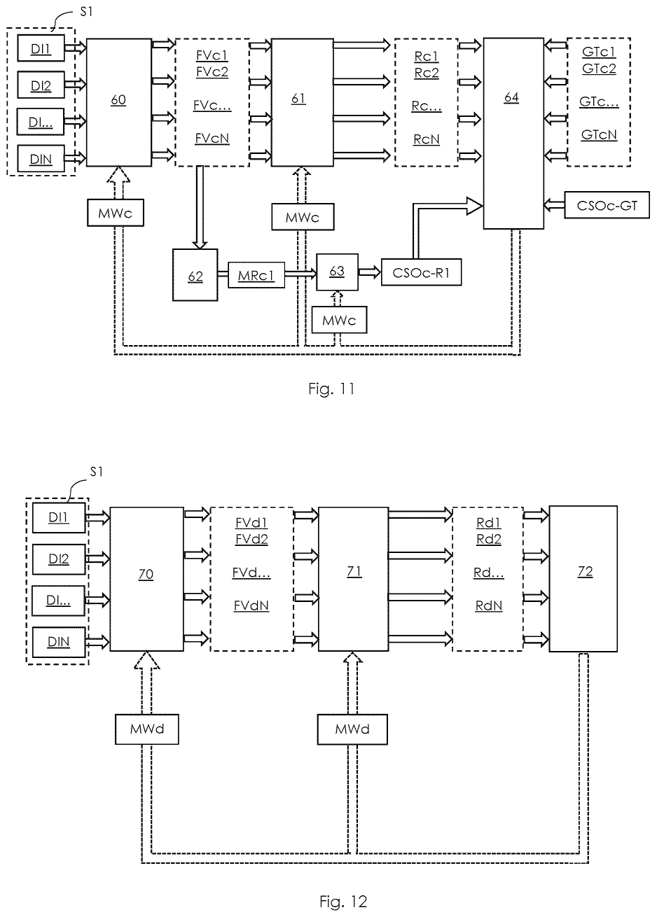

In a further example schematically illustrated in FIG. 11, the N digital images DI1, . . . , DIN (wherein N≥2) of the same object from different angles (as the case may be pre-processed or/and comprising the mentioned computer-generated digital images as mentioned above) are transferred to a neural network 60 of a machine learning system for digital image processing such as a deep learning system, e.g. a convolutional neural network system. The neural network 60 for digital image processing outputs for each digital image DI1, . . . , DIN (wherein N≥2) a feature vector FVc1, . . . , FVcN representing the information of the digital image. The information from the feature vectors FVc1, FVc2, . . . , FVcN is transferred to a . . . further neural network 61 of a machine learning system for classification, segmentation and/or object detection such as a deep learning system, e.g. a convolutional neural network system, being provided for processing the feature vectors FVc1, . . . , FVcN and outputting for each of the feature vectors FVc1, . . . , FVcN an own classification, segmentation and/or object detection results Rc1, . . . , RcN.

Furthermore, the information from the feature vectors FVc1, . . . , FVcN is transferred to a merging module 62 which outputs a feature vector processing result MRc1 comprising a feature vector representing an information of the digital images DI1, . . . , DIN (wherein N≥2). The pre-processing result MRc1 is transferred to a further neural network 63 of a machine learning system for classification, segmentation and/or object detection such as a deep learning system, e.g. a convolutional neural network system, being provided for processing the merging result MRc1 and outputting a classification, segmentation and/or object detection result CSOc-R1.

Each result Rc1, . . . , RCN and the result CSO-Rc1 is used as feedback for a training logic 64 based on loss function considering a provided set of ground truth GTc1, . . . , GTcN and CSOc-GT1 and generating according model weights MWc.

Advantageously, the neural network 64 comprises training logics for individual classification, segmentation and/or object detection regarding the individual images DI1, . . . , DIN (wherein N≥2) as well as regarding the set of the images S1.

If processed in this manner for a multitude of image sets S2, S3, . . . , Sn (wherein n≥2) of respectively N digital images of respective same objects from different angles, each of the according results can be used as feedback for a training logic 64 based on a loss function considering the provided ground truths mentioned above and generating according model weights MWc. For instance, for training logic 64 and for a supervised classification task, the Loss Function 1 shown above can be used. The model weights MWc are fed to the neural networks 60, 61, 63.

The trained machine learning system comprising the neural networks 60, 61, 63 is used for classification, segmentation and/or object detection, in particular for inspection purposes, e.g. for the digital images of milling inserts such as shown in FIG. 5 or the digital images of circuit boards such as shown in FIG. 6.

In a further example schematically illustrated in FIG. 12, the N digital images DI1, . . . , DIN (wherein N≥2) of the same object from different angles (as the case may be pre-processed or/and comprising the mentioned computer-generated digital images as mentioned above) are transferred to a neural network 70 of a machine learning system for digital image pre-processing such as a deep learning system, e.g. a convolutional neural network system. The neural network 70 for digital image pre-processing outputs for each digital image DI1, . . . , DIN a feature vector FVd1, . . . , FVdN representing the information of the digital image.

The information from the feature vectors FVd1, . . . , FVdN is transferred to a further neural network 71 of a machine learning system for classification, segmentation and/or object detection such as a deep learning system, e.g. a convolutional neural network system, being provided for processing the feature vectors FVd1, . . . , FVdN and outputting for each of the feature vectors FVd1, . . . , FVdN an own classification, segmentation and/or object detection results Rd1, . . . , RdN.

The results Rd1, . . . , RdN are fed to a training logic 72 of a machine learning system for classification, segmentation and/or object detection such as a deep learning system, e.g. a convolutional neural network system, being provided for unsupervised training not requiring ground truth. Ground truth is not required for the training logic 72, because the results Rd1, . . . , RdN should be consistent due to the similarity of the digital images DI1, . . . , DIN among each other. For training logic 72, the Loss Function 3 shown above can be used.

1-22. (canceled)

23. A digital image processing method, comprising the steps of: forming a dataset, in particular a training dataset, for a machine learning system for digital image processing, in particular image classification and/or object detection and/or segmentation; and using at least one set of digital images of a same captured object from different angles for forming the dataset.

24. The method according to claim 23, wherein the dataset is a training data set, and the digital image processing is at least one of image classification, object detection and segmentation.

25. The method according to claim 23, including using multiple sets of digital images respectively of the same captured object, wherein at least two of the sets differ in the captured object.

26. The method according to claim 25, wherein all of the sets differ in the captured object.

27. The method according to claim 24, including training the machine learning system for digital image processing using the training dataset.

28. The method according to claim 23, including capturing the digital images using a plenoptical device, in particular a kaleidoscope, or/and a camera array, the digital images of each set being captured in a single shot.

29. The method according to claim 28, wherein the plenoptical device is a kaleidoscope.

30. The method according to claim 23, further including processing at least one photographed or/and computer-generated image.

31. The method according to claim 30, including rendering the computer-generated image from the images of the same captured object from the different angles, and generating the computer-generated images considering a depth information comprising information relating to a distance of the object or sections or points of the object from a camera capturing the images.

32. The method according to claim 30, wherein the computer-generated image shows the object from an angle differing from the angles of digital images used as a basis for an according rendering process.

33. The method according to claim 27, including using the images of each set separately for training.

34. The method according to claim 27, including using the images of each set jointly for training, and jointly transferring the digital images of one of the sets to the machine learning system.

35. The method according to claim 27, including pre-processing the digital images before using the digital images for training.

36. The method according to claim 35, wherein the pre-processing comprises merging data from the images of the set of digital images of a same captured object considering different angles and/or depth information.

37. The method according to claim 23, further including processing that results of the digital image processing of the digital images as a set of results of the image processing of the images of the set of digital images of the same captured object.

38. The method according to claim 37, further including processing results of the digital image processing of the digital images in a further machine learning system for result processing, wherein the results are processed as sets, each set comprising results regarding digital images of a same captured object from different angles.

39. The method according to claim 23, including using the image processing for classifying images of workpieces for inspections purposes, wherein the inspection is for separating defective workpieces from non-defective workpieces.

40. The method according to claim 23, further including labeling the images using an information about appearance position shifts of the object and/or parts thereof in the images captured from different angles, wherein preferably at least one label issued for one of the images of a set is transferred to other images of the same set.

41. A computer program product, comprising instructions which, when the program is executed by a computer, cause the computer to carry out the steps of the method according to claim 23.

42. The computer program product according to claim 41, wherein the computer program product is a computer program stored on a data carrier, or a device, or is a signal sequence representing data suitable for transmission via a computer network.

43. The computer program product according to claim 42, wherein the data carrier is a RAM, a ROM, or a CD.

44. The computer program product according to claim 42, wherein the device is one of a personal computer, a device with an embedded processor, a computer embedded in a device, a smartphone, a computer of a photo and/or video camera.

45. The computer program product according to claim 42, wherein the signal sequence representing data suitable for transmission via a computer network is the Internet.

46. A device for digital image processing, comprising a system for carrying out the method according to claim 23.

47. A trained machine-learning model trained in accordance with the method according to claim 23.

48. A method comprising using a trained machine-learning model trained in accordance with the method according to claim 23 for digital image processing.

49. A device for digital image processing, configured to use the trained machine-learning model according to claim 47 for image classification and/or object detection and/or segmentation.

50. A data carrier signal that transmits the computer program product according to claim 41.
